(19) United States
(12) Patent Application Publication
(10) Pub. No.: US 2012/0267953 A1
(43) Pub. Date: Oct. 25, 2012

(54) APPARATUS AND METHOD FOR CONTROLLING AND SUPPLYING POWER TO ELECTRICAL DEVICES IN HIGH RISK ENVIRONMENTS

(76) Inventor: Kevin A. Doyle, Delray Beach, FL (US)

(21) Appl. No.: 13/089,601

(22) Filed: Apr. 19, 2011

(51) Int. Cl. H02J 1/00; H02M 7/02

(52) U.S. Cl. 307/31

(57) ABSTRACT

An integrated power hub and device controller apparatus, and associated operational method, are operable to control and supply power to electrical devices that operate in environments which create a high risk for the electrical devices to generate stray voltages and currents. According to one embodiment, the apparatus includes a plurality of converter circuits, a controller, and a communication interface. The converter circuits convert input AC power to DC power such that each converter circuit provides a DC output voltage for a respective electrical device. The converter circuits may be configured (e.g., with toroidal step-down transformers) so as to mitigate stray currents from flowing between the electrical devices. The controller is operable to generate control signals so as to at least partially control operations of the electrical devices. The communication interface is operably coupled to the controller and operable to provide the control signals to the electrical devices.

### BACKGROUND

1. Field of the Invention

The present invention relates generally to remotely controlling and distributing electrical power to electrical devices and, more particularly, to an apparatus and method for controlling and supplying power to electrical devices that operate in environments which create a high risk for the electrical devices to generate stray voltages and currents.

2. Description of Related Art

Decorative outdoor lighting is commonly used to improve the aesthetic beauty of one's home or business, especially at night. Such lighting includes landscape lighting, as well as lighting for fountains, swimming pools, and spas.

The use of decorative lighting requires that electrical power be supplied to the lighting and other electrical devices used therewith. Where the devices require input alternating current (AC) power to operate, power may be supplied to the electrical devices by running AC power lines (e.g., 60 Hz, 110V) directly from an electric service panel, an AC control switch (e.g., an AC timer), or an electrical outlet to the electrical devices. For example, most residential aquatic systems, such as in-ground swimming pools and spas, require AC power to be supplied around the pool to power halogen pool and spa lights, fountains, bubblers, laminar flow jets, and other decorative features. However, due to their proximity to water, electrical devices used with aquatic systems are at a high risk for generating stray voltages and currents, which increase the risk of electrical shock to users and repair personnel.

Alternatively, where decorative electrical devices require lower voltage direct current (DC) power to operate, DC conversion of AC power may occur at or near the electric service panel or electrical outlet and the resulting DC power may be run through low voltage lines to the devices. For example, use of a combination AC-to-DC step-down power transformer and timer near an electrical outlet is typical in low voltage, landscape lighting systems.

The use of light emitting diode (LED) technology in decorative lighting systems is becoming more prevalent, though is not yet commonplace due to its higher cost of implementation. LED devices operate using DC power and are much more efficient than their incandescent or halogen counterparts. Additionally, LED lighting devices typically last several times longer than incandescent or halogen bulbs. Further, some LED devices are available with processor-based control to enable the LED devices to operate according to preprogrammed lighting routines. Still further, some processor-based, LED devices include communication capability, which enable them to be controlled by remote controllers. Notwithstanding their benefits, LED devices can still produce stray voltages and currents under the right set of circumstance, especially when used in high risk environments.

Further, serially connecting multiple higher power LED lighting devices, such as those used with aquatic systems or as flood lights, from a single AC-to-DC transformer in a manner analogous to conventional low voltage landscape lighting systems can result in undesired voltage drops depending upon the length of the cable run from the transformer. For example, where the cable is run a couple hundred feet around a large swimming pool, the voltage at one device located twenty feet from the transformer along the cable run may be a few tenths of a volt higher than the voltage at another device located one-hundred fifty feet along the cable run due to losses in the cable. Additionally, while an AC-to-DC transformer inherently aids in isolating stray voltages produced on the AC side of the transformer from impacting electrical devices or individuals on the DC side of the transformer, an electrical fault on the DC side of the transformer can cause undesired stray currents between electrical devices that share common supply and return paths through the cable.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of an electrical system that includes an integrated power hub and device controller apparatus for controlling and supplying power to a plurality of electrical devices in accordance with one exemplary embodiment of the present invention.

FIG. 2 is an exploded, bottom, perspective view of an integrated power hub and device controller apparatus for controlling and supplying power to a plurality of electrical devices in accordance with another exemplary embodiment of the present invention.

FIG. 3 is a logic flow diagram of steps executed by an integrated power hub and device controller apparatus for controlling and supplying power to a plurality of electrical devices in accordance with a further exemplary embodiment of the present invention.

Skilled artisans will appreciate that elements in the figures are illustrated for simplicity and clarity and have not necessarily been drawn to scale. For example, the dimensions of some of the elements in the figures may be exaggerated alone or relative to other elements to help improve the understanding of the various embodiments of the present invention.

### DETAILED DESCRIPTION

Generally, the present invention encompasses an integrated power hub and device controller apparatus, and associated operational method, operable to control and supply power to electrical devices that operate in environments which create a high risk for the electrical devices to generate stray voltages and currents. According to one embodiment, the apparatus includes a plurality of converter circuits, a controller, and a communication interface. The converter circuits convert input alternating current (AC) power to direct current (DC) power such that each converter circuit provides a DC output voltage for a respective electrical device. The converter circuits are configured so as to mitigate stray currents from flowing between the electrical devices. For example, each converter circuit may include a step-down transformer, such as a toroidal transformer, to provide isolation between the electrical devices. In one embodiment in which the electrical devices require similar operating voltages (e.g., such as would likely be the case where the electrical devices include LED lighting for a particular system, such as an aquatic system or a decorative lighting system), the converter circuits may be substantially identical and, as a result, the DC output voltage from each converter circuit may be substantially identical (e.g., 12 volts DC). The controller is operable to generate control signals so as to at least partially control operations of the electrical devices. The communication interface is operably coupled to the controller and operable to provide the control signals to the electrical devices (e.g., over a wired or wireless medium). According to one exemplary embodiment, the apparatus further includes a housing that surrounds at least the converter circuits and the controller. The housing may be designed to be installable near a system incorporating the electrical devices so as to minimize the distance of electrical wiring between the integrated apparatus and the electrical devices.

According to another embodiment, the electrical devices may be used in connection with an aquatic system, such as a swimming pool, a fountain, or a spa, for example. In such a case, the electrical devices may be controllable to create visual effects with respect to the aquatic system, wherein control signals communicated to the electrical devices via the communication interface cause the electrical devices to create the visual effects. For example, the electrical devices associated with a particular aquatic system may include LED lights, LED-illuminated bubblers, and/or LED-illuminated laminar jets which create an illuminated water show based on the control signals from the controller. In this case, the controller may be pre-programmed with the sequencing instructions for creating the visual and/or water effects or may receive the sequencing instructions from a remote host device via a second communication interface. Where the controller is pre-programmed with instructions for controlling the electrical devices, the controller may generate control signals based on the instructions so as to individually control operations of the electrical devices. Where the instructions are received as host control signals from a remote host device, such as a master controller, the apparatus controller may generate one or more of the electrical device control signals in response to the host control signals.

In an alternative embodiment, the apparatus may include a timer and/or a dusk-dawn sensor operably coupled to the controller. When a timer is included, the controller may be further operable to generate one or more of the control signals based on an output of the timer. For example, the controller may be operable to generate a control signal that causes one or more of the electrical devices to turn on when an output of the timer indicates that a particular set time (e.g., “on time”) has occurred. Additionally, the controller may be further operable to generate a control signal that causes one or more of the electrical devices to turn off when an output of the timer indicates that a different set time (e.g., “off time”) has occurred. When a dusk-dawn sensor is included in the apparatus, the controller may be operable to generate one or more of the control signals based on an output of the dusk-dawn sensor. For instance, the controller may be operable to generate a control signal that causes one or more of the electrical devices to turn on when an output of the dusk-dawn sensor indicates that the sensor has detected dusk conditions. Additionally, the controller may be operable to generate a control signal that causes one or more of the electrical devices to turn off when an output of the dusk-dawn sensor indicates that the sensor has detected dawn conditions.

In yet another embodiment, the controller may be operable to detect which electrical devices are currently electrically coupled to the apparatus and controllable. For example, the apparatus may be configured to control and supply electrical power to up to a maximum quantity of electrical devices. As a result, any number of electrical devices at or below the maximum may be electrically connected to the apparatus at any particular time. Therefore, according to one embodiment, the controller may be operable to provide polling signals to the communication interface for communication to the electrical devices. The communication interface, which may be a wired serial interface (e.g., an RS485 or RS232 interface), a wireless interface (e.g., a Zigbee, Bluetooth, Infrared Data Association (IrDA), Wi-Fi, or other short or medium-range wireless transmission interface), or any other appropriate communication interface, then communicates each polling signal over an associated communication network to the electrical devices. Each polling signal may identify a particular electrical device or set of electrical devices from which the apparatus controller desires a response. Alternatively, each polling signal may be a generally broadcast polling signal in accordance with the applicable communication protocol requesting that each electrical device (or its associated controller or processor, which may be pre-programmed to communicate using the particular communication protocol) respond with the device's identifier, such as a serial number, a link or network layer address, or other identifying indicia. The apparatus controller may be further operable to receive the electrical devices' responses to the polling signal or signals via the communication interface and determine which of the electrical devices are electrically coupled to the apparatus based on the one or more responses. For example, the apparatus controller may determine that only those electrical devices which responded to the polling signal or signals are coupled to the controller. As a result, the apparatus controller can periodically determine whether new electrical devices have been added to, or existing electrical devices have been replaced in, the system controlled by the apparatus.

In yet another embodiment, the apparatus controller may use the polling signals or other control signals to request information from the electrical devices. Such information may include data stored in a memory of each device, such as an identifier for the device; warranty information; date and time of entry into service; cumulative hours of use; instantaneous, average, and/or cumulative power consumption; codes for detected problems, and/or any other data stored by the electrical device. In this embodiment, the apparatus controller may be further operable to receive the data from the electrical devices via the communication interface and compare at least some of the data to associated thresholds. For example, the apparatus controller may be operable to compare the cumulative hours of use to the hours of use guaranteed or warranted by the electrical device manufacturer (e.g., which may be in the warranty information received from the device) to determine whether the electrical device is still under warranty. Alternatively or additionally, the controller may compare the reported power consumption to a threshold in order to determine whether the electrical device meets energy usage mandates or qualifies to be listed as energy efficient.

In yet another embodiment, the apparatus may include a memory and/or a user interface. Where the apparatus includes a memory, the apparatus controller may be further operable to determine power usage data for each of the plurality of electrical devices and store the power usage data in the memory. For example, the controller may receive power consumption data directly from an electrical device in response to a polling signal, a control signal, or other request for information. Alternatively, the apparatus may include voltage and current detectors coupled to the DC power distribution lines, and the controller may determine power usage for the electrical devices based on the outputs of the voltage and current detectors. Where the apparatus includes a user interface, the user interface may be coupled to the controller and used by the controller to indicate statuses of the plurality of electrical devices. For example, the user interface may be a series of LEDs corresponding to the quantity of electrical devices supported by the apparatus, and the controller may illuminate each LED that corresponds to an electrical device which is receiving power from the apparatus and is under the control of the controller. In an alternative embodiment, the user interface may be more complex and include, for example, an LED display or a liquid crystal display (LCD), which may display more detailed information regarding the electrical devices as provided by the controller.

In a further embodiment, the control signals generated by the apparatus controller may be used to control operations of the electrical devices on an individual basis. For example, each control signal may be individually addressed to a particular device to control the device's operation. In such a manner, the controller may create, in one embodiment, a chasing light pattern by turning on and off multiple colored lights in a sequence. Alternatively, the control signals generated by the apparatus controller may be used to control operations of the electrical devices on a group basis. For example, each control signal may be addressed to a group of electrical devices to control the devices' collective operation. In such a manner, the controller may create, in one embodiment, a combination water and light pattern by turning on multiple lighting and water processing devices (e.g., bubblers, fountains, and/or laminar jets) simultaneously.

In another embodiment, the integrated power hub and device controller apparatus may be operable to control and supply power to electrical devices that are used in connection with an aquatic system. According to this embodiment, the apparatus includes an AC power input to receive AC power from an external AC power source (e.g., an electrical outlet, an electrical service panel, a generator, or any other AC power source), a plurality of AC-to-DC converter circuits, a plurality of DC power output connectors, a controller, and a communication interface. The converter circuits convert the input AC power to DC power such that each converter circuit provides a DC output voltage for a respective electrical device. The converter circuits are configured so as to mitigate stray currents from flowing between the electrical devices. Each DC power output connector is electrically coupled to a respective converter circuit and supplies the DC output voltage of the converter circuit to a respective electrical device (e.g., via a desired wiring configuration). The controller in this embodiment is operable to generate control signals that cause the electrical devices to create visual effects with respect to the aquatic system. The communication interface is operably coupled to the controller and operable to provide the control signals to the electrical devices (e.g., over a wired or wireless medium).

In yet another embodiment, the integrated power hub and device controller apparatus may be operable to control and supply power to electrical devices that operate in environments which create a high risk for the electrical devices to generate stray voltages and currents. According to this embodiment, the apparatus includes a plurality of AC-to-DC converter circuits, a first communication interface, a controller, and a second communication interface. The converter circuits convert input AC power to DC power such that each converter circuit provides a DC output voltage for a respective electrical device. The converter circuits are configured so as to mitigate stray currents from flowing between the electrical devices. The first communication interface is operable to receive host control signals from a remote host device and may be a wired or wireless interface. The controller is operably coupled to the first communication interface and operable to generate device control signals in response to the host control signals so as to at least partially control operations of the electrical devices. The second communication interface is operably coupled to the controller and operable to provide the device control signals to the electrical devices (e.g., over a wired or wireless medium).

In a further embodiment, a method is provided for an integrated power hub and device controller apparatus to control and supply power to electrical devices that operate in environments which create a high risk for the electrical devices to generate stray voltages and currents. According to this embodiment, the apparatus receives AC power from a single AC power source, converts the received AC power into a plurality of substantially isolated DC output voltages, supplies each DC output voltage to a respective one of the electrical devices, generates control signals for at least partially controlling operations of the electrical devices, and communicates the control signals to the electrical devices. According to another embodiment, the apparatus may be communicatively coupled to a remotely located host device. In such a case, the apparatus may optionally receive a host control signal from the host device and generate at least one of the device control signals responsive to the host control signal. Such an embodiment may be employed where remote control of the integrated apparatus either alone or together with one or more other devices (which may include other integrated apparatuses) is desired, such as in a large lighted water display.

In yet another embodiment, the method employed by the integrated apparatus may optionally cause the apparatus to communicate polling signals to each of the electrical devices, receive one or more responses to the polling signals from a respective one or more of the electrical devices, and determine which of the electrical devices are electrically coupled to the apparatus based on the one or more responses. Additionally, the integrated apparatus may further determine that an electrical device is not electrically coupled to the apparatus when a response to a polling signal communicated to the electrical device is not received (e.g., within a predetermined period of time after communication of the polling signal or after communication of a predetermined quantity of polling signals). In a further embodiment in which one or more of the electrical devices include memory operable to store data relating to the respective electrical device, the polling signal communicated by the integrated apparatus may include a request for at least some of the stored data or the apparatus may send a separate request for some or all of the stored data (e.g., after determining via the polling that the electrical device is electrically coupled to the apparatus).

By providing an integrated power hub and device controller apparatus, and associated operational method, in this manner, the present invention integrates power distribution and electrical device control into a single housing that may be positioned near a system that includes multiple electrical load devices to be serviced. Positioning of the power distribution facility near the system reduces line losses between the facility and the electrical loads being supplied. Additionally, through use of a separate transformer-based, AC-to-DC converter circuit for each electrical load device, the integrated apparatus isolates the load devices from stray currents which may be generated due to the devices' location in a high risk area, such as in or around an aquatic system. Further, providing for detection of new and/or replacement electrical load devices that are coupled to the apparatus allows the apparatus to keep track of which electrical devices are present for purposes of sending control signals, requesting information, and/or performing other functions (e.g., power usage monitoring). Thus, the present invention provides an enhanced, integrated, multi-function apparatus that may be used to replace the separate power distribution and control devices currently used to supply power to and control decorative outdoor lighting and aquatic devices.

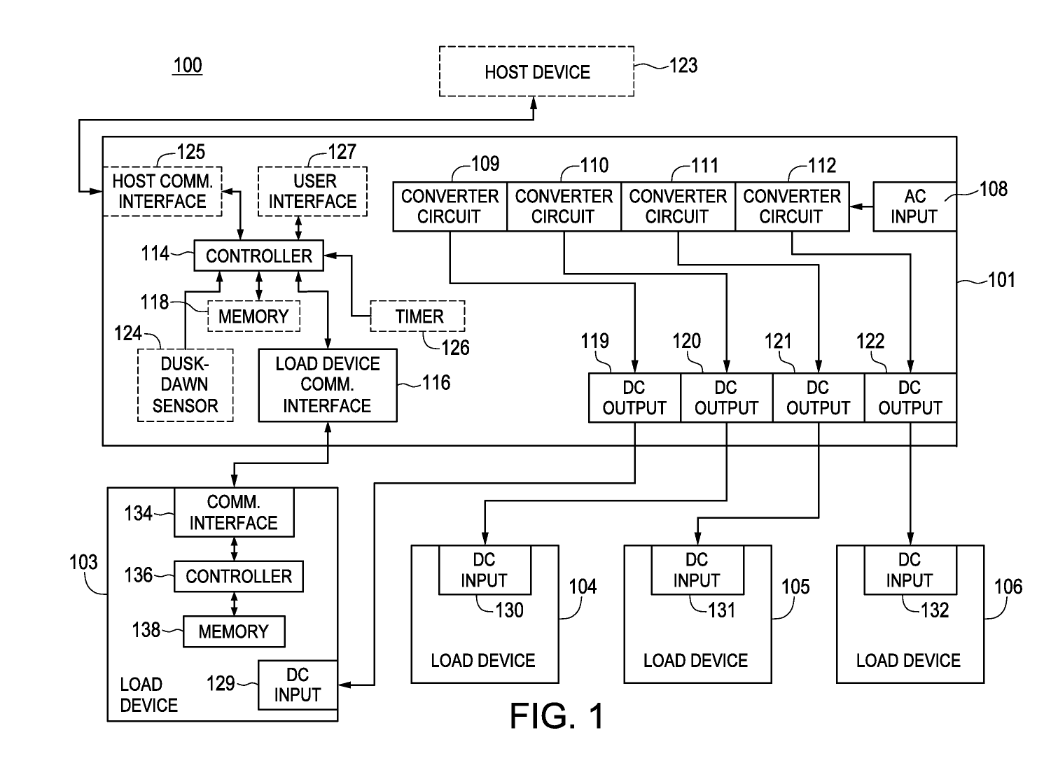

Embodiments of the present invention can be more readily understood with reference to FIGS. 1-3, in which like reference numerals designate like items. FIG. 1 illustrates a block diagram of an electrical system 100 that includes an integrated power hub and device controller apparatus 101 for controlling and supplying power to a plurality of electrical devices 103-106 (four shown for illustration purposes only) in accordance with one exemplary embodiment of the present invention. The integrated power hub and device controller apparatus 101 includes, inter alia, an AC power input circuit 108, a plurality of AC-to-DC converter circuits 109-112 (four shown for illustration purposes only), a controller 114, and an electrical load device communication interface 116. The apparatus 101 may also include memory 118, a plurality of DC output connectors 119-122 (four shown for illustration purposes only), a dusk-dawn sensor 124, a host device communication interface 125, a timer 126, a user interface (UI) 127, and various other components depending upon the particular desired functionality of the apparatus 101. The integrated apparatus 101 may operate autonomously or in response to host control signals supplied by a host device 123, such as a master controller. Alternatively, the integrated apparatus 101 may be incorporated into the host device 123.

The AC power input circuit 108 may be any conventional means for receiving power from an AC power source (not shown), such as an electrical outlet or an electrical service panel. For example, the AC power input circuit 108 may be a printed circuit board to which wires are soldered or otherwise attached, an AC plug connector, and/or other appropriate components that facilitate connection to power cabling emanating from the power source. The AC power input 108 supplies AC power to the AC-to-DC converter circuits 109-112, which are electrically coupled to the AC power input 108. The converter circuits 109-112 convert the received AC power to respective levels of DC output power. The quantity of converter circuits 109-112 included in the integrated apparatus 101 preferably equals the maximum quantity of electrical devices 103-106 that may receive power from the apparatus 101, such that each converter circuit 109-112 supplies DC power to a respective one of the electrical devices 103-106. However, one skilled in the art will readily recognize and appreciate that each converter circuit 109-112 may be designed to supply DC power to more than one electrical device 103-106. As a result, in an alternative embodiment, the quantity of converter circuits 109-112 may be less than the quantity of electrical load devices 103-106 receiving power from the integrated apparatus 101.

In one embodiment, each converter circuit 109-112 includes, inter alia, a toroidal step-down transformer, a voltage rectifier, and one or more smoothing or output capacitors to produce a respective DC output voltage. The DC output voltage may then be supplied to a respective DC output connector 119-122. The quantity of DC output connectors 119-122 preferably matches the quantity of independent and substantially isolated DC output voltages produced by the converter circuits 109-112. In one embodiment, isolation of the DC output voltages results from the use of step-down transformers within the converter circuits 109-112.

The DC output voltages may be substantially identical or may be different depending upon the configurations of the converter circuits 109-112 and the voltage requirements of the electrical devices 103-106 being supplied power from the integrated apparatus 101. In one embodiment in which the integrated apparatus 101 is used to supply DC power to various LED-based electrical devices 103-106 used in an aquatic system (e.g., lights, illuminated bubblers, illuminated fountains, and/or illuminated laminar jets), the converter circuits 109-112 may be substantially identical and operable to convert the AC input power (e.g., 110 VAC or 220 VAC) to the particular level of DC voltage (e.g., 12 VDC) required by the electrical devices 109-112. Wires may be connected to the DC outputs 119-122 and run to their respective electrical devices 103-106 (e.g., in plastic conduit tubes) such that each DC output 119-122 supplies DC power to a respective one of the electrical devices 103-106.

The controller 114 may be a microprocessor or microcontroller that operates in accordance with one or more stored programs. The program or programs may be stored in internal memory of the controller 114 or in memory 118 electrically coupled to the controller 114. Where the integrated apparatus 101 is used in connection with an aquatic system, one of the stored programs may be a program that enables the controller 114 to individually control the electrical devices 103-104 to create visual effects, such as color sequencing (e.g., color chasing), color blending, or other visual effects. In an alternative embodiment in which the electrical devices 103-106 include communication capability, the stored programs may include programs for polling the electrical devices 103-106 to determine their presence or connectivity to the apparatus 101 and/or for requesting data, such as time in service, warranty information, power consumption, error codes, and other status-related information, from the devices 103-106. The controller 114 may optionally include a timer or be electrically coupled to an external timer 126 (which may be resident within the apparatus 101 or external thereto). When included, the timer 126 may be used to track or record the amount of time that one or more of the electrical devices 103-106 are turned on. In this case, the amount of time recorded is provided by the controller 114 to the memory 118 for storage as time data. Alternatively, the timer 126 may be used in a more conventional sense to establish the time of day at which the controller 114 should turn one or more of the electrical devices 103-106 on or off and/or execute a stored program relating to activating and/or deactivating the electrical devices 103-106.

The integrated apparatus 101 may optionally include memory 118 to store a variety of information and data, including programs executable by the controller 114 and/or information received from some or all of the electrical devices 103-106, such as power usage information, time in use information, warranty information, reported problems, and so forth, as described in more detail below. The memory 118, which may be a separate element as depicted in FIG. 1 and/or may be integrated into the controller 114, can include random access memory (RAM), read-only memory (ROM), flash memory, electrically erasable programmable read-only memory (EEPROM), removable memory, and/or various other forms of memory as are well known in the art. It will be appreciated by one of ordinary skill in the art that the various memory components can each be a group of separately located memory areas in the overall or aggregate apparatus memory 118 and that the memory 118 may include one or more individual memory elements.

The communication interface 116 for communicating with the electrical load devices 103-106, when the devices 103-106 are appropriately configured for communicating, may be any conventional form of electronic communication means. In a preferred embodiment, the load device communication interface 116 is a RS485 serial interface. Alternatively, the communication interface 116 may be a short-range wireless interface, such as a wireless transceiver that communicates using the Zigbee, Bluetooth, IrDA, or Wi-Fi protocol, or a long-range wireless interface, such as wireless transceiver operable on a wireless wide area network. According to one embodiment, the communication interface 116 is selected to enable the controller 114 to individually control some or all of the electrical devices 103-106 as required by one or programs stored in memory 118 or by one or more host control signals received from a host device 123.

When included, the dusk-dawn sensor 124 may be an optic sensor operable to detect the presence or absence of a minimum level of ambient light. For example, when at least a predetermined level of light is detected, the output of the sensor 124 may be a voltage (e.g., a logic zero) to indicate a dawn condition and, when the predetermined level of light is not detected, the output of the sensor 124 may be a voltage (e.g., a logic one) to indicate a dusk condition. The controller 114 may be coupled to the dusk-dawn sensor 124 and use the output therefrom as a trigger to activate or de-activate one or more of the electrical devices 103-106. For example, the controller 114 may turn on one or more of the electrical devices 103-106 upon detection of a dusk condition by the dusk-dawn sensor 124 and turn off one or more of the electrical devices 103-106 upon detection of a dawn condition by the dusk-dawn sensor 124.

When the integrated apparatus 101 is configured to receive instructions (e.g., control signals) from a host device 123, the apparatus 101 includes a host device communication interface 125. The host device interface 125 may be a wired or wireless interface, as may be appropriate for the distance and terrain between the host device 123 and the integrated apparatus 101. For example, where the host device 123 and the integrated apparatus 101 are in close proximity, a wired interface or short-range wireless interface may be used. Alternatively, where the host device 123 and the integrated apparatus 101 are separated by a long distance, a wide area wireless interface, such as a transceiver for a cellular or other wide area wireless system, may be employed.

In yet another embodiment, the integrated apparatus 101 may include a user interface 127, such as one or more LEDs, an LCD or LED display, a keypad, a speaker, or any other device that provides information to or receives information or inquiries from a user of the apparatus 101 or service personnel. When included, the user interface 127 is operably coupled to the controller 114 and may be used by the controller 114 to indicate statuses of the electrical devices 103-106 and/or receive requests for information relating to operation of the electrical devices 103-106 and/or the integrated apparatus 101. For example, the user interface 127 may be a set of LEDs, where each LED corresponds to a particular one of the electrical devices 103-106. The LEDs can be used by the controller 114 to indicate which electrical device 103-106 is on or off (e.g., illumination of an LED may indicate that its associated electrical device 103-106 is currently on, whereas no illumination may indicate that the associated electrical device 103-106 is currently off) and/or which electrical devices 103-106 are currently being controlled.

DC power for the control-related components of the integrated apparatus 101 (e.g., the controller 114, the memory 118, the timer 126, the dusk-dawn sensor 124, the communication interfaces 116, 125, the user interface 127 and so forth) may be provided by any one or more of the converter circuits 109-112 or a separate converter circuit (not shown). Where one or more of the converter circuits 109-112 is used to supply DC power to the control-related components, a divider circuit may be included to drop the supply voltage to a level (e.g., 5 VDC) usable by the control-related components.

The electrical devices 103-106 may be any electrical devices that are remote from the integrated apparatus 101 and require DC power to operate. Accordingly, each electrical device 103-106 includes a DC input connector 129-132 to receive DC power from the integrated apparatus 101. For example, the electrical devices 103-106 may include LED lights, landscape ornamentation or decorations, LED pool lights, illuminated water bubblers, fountains, illuminated laminar jets, decorative waterfalls, or any other devices that are operate in environments, such as outside or near sources of water (e.g., swimming pools, fountains, ponds, lakes, canals, streams, rivers, etc.), that create a high risk of stray currents or voltages. The electrical devices 103-106 may be used in connection with a system, such as an aquatic system, to provide visually pleasing effects to those using or viewing the system.

In one embodiment, some or all of the electrical devices 103-106 include a communication interface 134, a controller 136, and memory 138. Communication interface 134, controller 136, and memory 138 are shown in FIG. 1 as being included in electrical device 103 solely for purposes of illustration. One of ordinary skill in the art will readily recognize and appreciate that similar communication interfaces, controllers, and memory may be included in some or all of the other electrical devices 104-106 that are electrically coupled to the integrated apparatus 101. Communication interface 134 may be selected to coincide with the load device interface 116 of the integrated apparatus 101, or vice versa. Thus, communication interface 134 may be a wired interface, such as a RS485 interface, or a wireless interface, such as a short-range wireless interface. Controller 136 may be a microcontroller or similar processor operable to respond to control signals, polling signals, and other signals communicated by the integrated apparatus controller 114.

Memory 138 may store a variety of information and data, including programs executable by controller 136 and/or data generated by controller 136 and relating to the electrical device 103-106. For example, memory 138 may store power usage data for its electrical device 103-106 (e.g., as measured by controller 136 using appropriate voltage and current detection circuitry), time in use information, prestored warranty information, problem reports as generated by controller 136, and so forth. Memory 138, which may be a separate element as depicted in FIG. 1 and/or may be integrated into controller 134, can include RAM, ROM, EEPROM, and/or various other forms of memory as are well known in the art. It will be appreciated by one of ordinary skill in the art that the various memory components can each be a group of separately located memory areas in the overall or aggregate device memory 138 and that memory 138 may include one or more individual memory elements.

In operation, the integrated apparatus 101 supplies DC power to electrically coupled load devices 103-106 and controls, or at least partially controls, operation of the load devices 103-106. Input AC power is received by the AC input 108 and passed along to the converter circuits 109-112. The converter circuits 109-112 convert the AC power to DC power based on their particular designs (e.g., their respective transformers' primary-to-secondary windings ratios). The output DC power of each converter circuit 109-112 is supplied to a respective DC output connector 119-122. Wiring from the DC output connectors 119-122 delivers the DC power to the DC inputs 129-132 of the electrical devices 103-106.

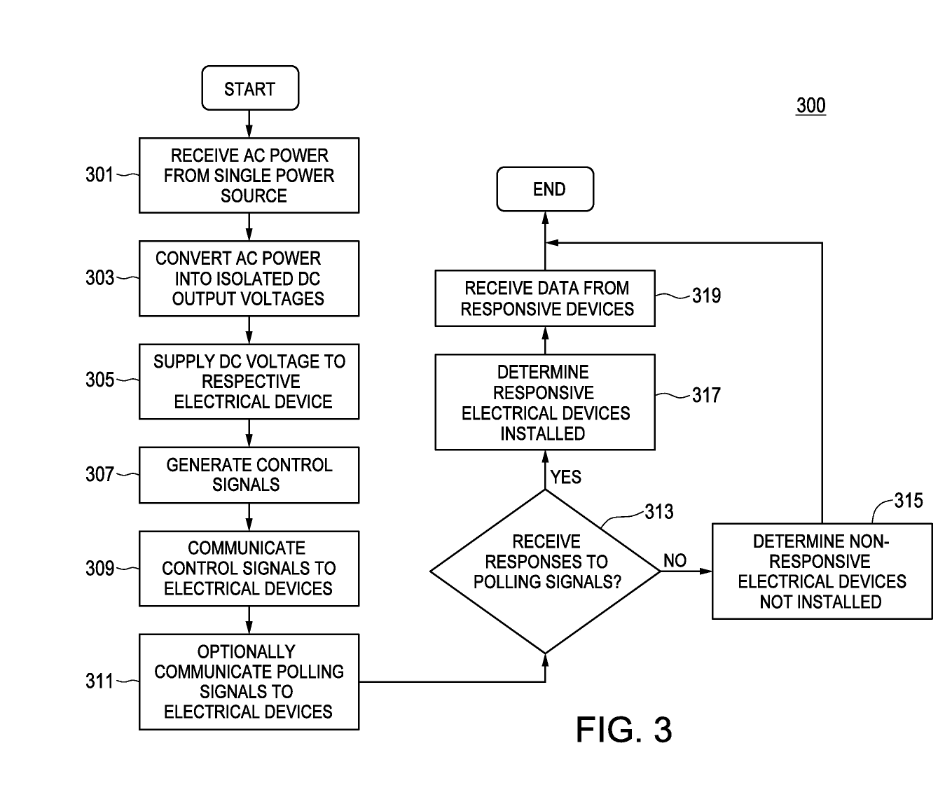

The integrated apparatus' controller 114 sends control signals to the electrical devices 103-106 (or to those electrical devices 103 with communication functionality) via the load device communication interface 116. The transmitted control signals may include instructions for individually or collectively operating the electrical devices 103-106 (e.g., instructions to turn the devices 103-106 on and off, to change lighting features (e.g., color, brightness, effects), or to update programs stored in the device memories 138) or requests for information from the electrical devices 103-106 (e.g., requests for warranty information, date of installation information, time in use information, power usage/consumption information (e.g., where the electrical device 103-106 includes power consumption determination circuitry and the determined power consumption data is stored in device memory 138)). The integrated apparatus controller 114 may also send polling signals to the electrical devices 103-106 to determine their statuses and/or to request information. For example, the controller 114 may periodically send polling signals (e.g., once every few minutes) to the electrical devices 103-106 to determine which electrical devices 103-106 are currently connected to the integrated apparatus 101. In one embodiment, the controller 114 determines that an electrical device 103-106 is connected to the apparatus 101 when the electrical device 103-106 responds to the polling signal. The polling signal may also include a request for information, as discussed above, such that the electrical device 103-106 responds to the poll with the requested information. The requested information may enable the controller 114 to perform a variety of analyses relating to the electrical devices 103-106, including determining power usage and/or determining whether an electrical device 103-106 may be defective, in need of servicing, or out of warranty. The control and polling signals are received by the electrical devices 103 via their respective communication interfaces 134 and responses are provided by the devices' controllers 136. Additional details relating to operation of the integrated apparatus 101 are provided below with respect to FIG. 3.

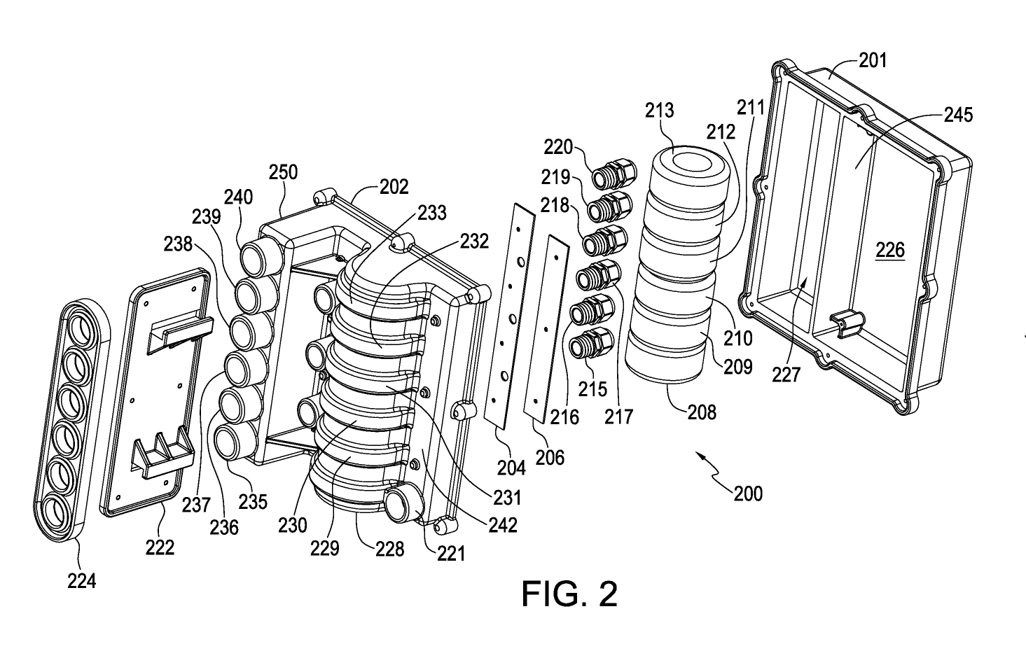

FIG. 2 is an exploded, bottom, perspective view of an integrated power hub and device controller apparatus 200 for controlling and supplying power to a plurality of electrical devices 103-106 in accordance with an alternative exemplary embodiment of the present invention. The apparatus 200 includes, inter alia, a housing lid 201, a housing bottom 202, one or more DC component circuit boards 204, an AC component circuit board 206, a plurality of toroidal transformers 208-213, and a plurality of DC output connectors 215-220. FIG. 2 essentially illustrates one implementation for the integrated power hub and device controller apparatus 101 of FIG. 1, except that the apparatus 200 depicted in FIG. 2 includes six converter circuits and six DC output connectors 215-200 instead of four as illustrated in FIG. 1.

The housing lid 201 and the housing bottom 202 collectively form a housing of the integrated apparatus 200, which surrounds, retains and protects the electrical components of the apparatus 200. The housing lid and bottom 201, 202 may be fabricated (e.g., molded) from a rigid plastic material and be held together with screws (not shown). To prevent moisture from entering the housing, a gasket (not shown) may be installed between the two housing components 201, 202.

In one embodiment, the housing bottom 202 includes an AC line receptor 221 for receiving the input AC power wires from an AC power source (e.g., an electrical service panel), a plurality of transformer receptacles 228-233, a plurality of DC connector sockets 235-240, an AC component circuit board attachment well 242, and a DC component circuit board attachment well (not shown). The AC component circuit board 206, which supports the traces, transformers' primary winding inputs, and other circuitry that receives the AC input power, is secured to a floor of the AC component circuit board attachment well 242, such as with screws, rivets, or clips. Similarly, the DC component circuit board(s) 204 is secured to a floor of the DC component circuit board attachment well. The DC component circuit board(s) 204 supports the traces, transformers' secondary winding outputs, rectifier circuits, filter capacitors, wires, and other circuitry that delivers the DC output power to the DC output connectors 215-220, and further supports the control and communication circuitry for the apparatus 200, such as the controller 114, the load device communication interface 116, and when included, the memory 118, the timer 126, the dusk-dawn sensor 124, the user interface 127, and the host device communication interface 125.

Each transformer 208-213 is positioned in a respective one of the transformer receptacles 228-233 to form a type of stacked arrangement, and each DC output connector 215-220 is positioned in a respective one of the DC connector sockets 235-240. The housing lid 201 may include a pair of chambers 226, 227 separated by a dividing wall 245 to separate the transformers 208-213 and AC circuitry from the noise-sensitive control circuitry. The depth and overall volume of chamber 226 is designed to receive those portions of the transformers 208-213 that rise out of the housing bottom 202. Chamber 227 may be the same depth as chamber 226, as illustrated in FIG. 2, in order to simplify the housing lid design or may be otherwise configured to enclose the control and DC output circuitry of the integrated apparatus 200. Dividing wall 245 may extend from the top of the housing lid 201 so as to contact the housing bottom 202 when the housing is assembled to effectively isolate the AC circuitry and transformers 208-213 from the DC and control circuitry.

The integrated apparatus 200 may also optionally include a plastic pipe or tubing holder 224 that includes a plurality of apertures which coincide with the quantity of output DC connectors 215-220. The pipe holder 224 may be used to support plastic (e.g., polyethylene or polyvinylchloride (PVC)) conduit or tubing containing the output DC power lines.

The integrated apparatus 200 may further optionally include a plastic bracket 222 attached to a back side 250 of the housing bottom 202. The bracket 222 may be used to secure the housing bottom 202 (and the housing as a whole) to a stake or other support structure which may be installed in landscaping proximate a system that includes the electrical devices 103-106. By locating the integrated apparatus 101, 200 near the electrical devices 103-106 under control (e.g., within two meters from a swimming pool, fountain or other system with which the electrical devices 103-106 are used), line losses between the integrated apparatus 101, 200 and the electrical devices 103-106 may be kept to a minimum, thereby reducing the likelihood of significant voltage drops between the DC outputs of the apparatus 101, 200 and the electrical devices 103-106.

As disclosed above, the integrated apparatus 101, 200 preferably includes a separate converter circuit 109-112 for each DC output 119-122 provided by the apparatus 101. One benefit of such a configuration is that the converter circuit DC outputs are isolated from one another so as to mitigate stray currents from flowing between the electrical devices 103-106. Such isolation is enhanced where each converter circuit 109-112 includes a toroidal transformer 208-213 due to the inherent isolation effects of such transformers 208-213. The mitigation of stray currents and voltages is particularly important when the integrated apparatus 101, 200 supplies electrical power to electrical devices 103-106 used in connection with aquatic systems, such as a swimming pools, fountains, and the like.

FIG. 3 is a logic flow diagram 300 of steps executed by an integrated power hub and device controller apparatus 101, 200 for controlling and supplying power to a plurality of electrical devices 103-106 in accordance with an exemplary embodiment of the present invention. According to the exemplary logic flow, the integrated apparatus 101, 200 receives (301) AC power from a single AC power source, such as an electrical service panel or electrical outlet, and converts (303) the AC power into a plurality of substantially isolated DC output voltages. In one embodiment, the AC-to-DC power conversion is performed by a set of converter circuits 109-112 that include a set of electrical transformers 208-213, which are used to step-down the input AC voltage to levels usable by the electrical devices 103-106. Each converter circuit 109-112 may supply a respective one of the DC output voltages. Use of a transformer-based converter circuit to supply each DC output voltage provides isolation between the DC outputs as a result of the inherent isolation provided by the transformers 208-213. Such isolation helps reduce the likelihood of stray voltages and currents occurring between the electrical devices 103-106, which is particularly beneficial where the electrical devices 103-106 operate in environments, such as outdoors and/or near aquatic systems, that create a high risk for the electrical devices 103-106 to generate stray voltages and currents. Each DC output voltage may be supplied (305) though a respective DC output connector 119-122, 215-220 to a respective electrical load device 103-106 that is electrically coupled to the DC output connector 119-122, 215-220 (e.g., via appropriate wiring).

Besides performing electrical power conversion and distribution, the integrated apparatus 101, 200 also generates (307) control signals for at least partially controlling operations of electrical devices 103-106 that are controllable and electrically coupled to the integrated apparatus 101, 200. The control signals may be messages or data signals formatted in accordance with the particular communication protocol used between the integrated apparatus 101, 200 and the electrical devices 103-106. In one embodiment, such a protocol is an RS485 protocol, although various other conventional wired or wireless signaling protocols may be used. The control signals may be generated by a controller 114 of the integrated apparatus 101, 200 either in response to receipt of one or more host control signals from a host device 123 or autonomously (e.g., in conjunction with a device control program (e.g., a light show program) being executed by the controller 114). A control signal generated by the integrated device's controller 114 may fully control operation of an electrical device 103-106 by, for example, causing the electrical device to turn its primary functionality on or off (e.g., turn an LED light on or off) or may only partially control operation of an electrical device 103-106 by, for example, causing the electrical devices to modify is primary functionality (e.g., change colors of an LED light) or turn its secondary functionality on or off (e.g., turn on or off the lighting of a fountain, but maintain operation of the fountain's pump). For example, where the electrical devices 103-106 form part of an aquatic system that is capable of providing visual and/or water effects, the control signals generated by the integrated apparatus' controller 114 may cause the electrical devices 103-106 to create the intended visual and/or water effects.

The generated control signals are communicated (309) to the electrical devices 103-106 via a communication interface 116 of the integrated apparatus 101, 200. The communication interface 116 may be wired (e.g., an RS-485 interface) or wireless (e.g., Zigbee, Wi-Fi, Bluetooth, IrDA, or short-range radio). The communication interface 116 may also be used to receive data and/or messages from the electrical devices 103-106 as discussed in more detail below.

The integrated apparatus 101, 200 may also optionally generate and communicate (311) polling signals to the electrical devices 103-106. For example, the apparatus controller 114 may generate polling signals on a periodic basis (e.g., every 30 minutes) and provide the polling signals to the apparatus' load device communication interface 116 for communication to the electrical devices 103-106. The polling signals may be used to determine which electrical devices 103-106 are currently electrically coupled to the apparatus 101, 200 or whether any new electrical device 103-106 has been electrically coupled to the apparatus 101, 200, and/or to request information from the electrical devices 103-106. Each polling signal may be addressed to a particular one of the electrical devices 103-106 or the polling signal may be a broadcast signal that requires a response from all electrical devices 103-106 that receive it.

After the polling signal or signals have been sent, the integrated apparatus 101, 200 determines (313) whether it received one or more responses to the polling signal(s) via the load device communication interface 116. If one or more polling signal responses were received, the integrated apparatus controller 114 determines which electrical devices 103-106 are installed based on the received responses. For example, the controller 114 may determine (315) that the electrical devices that did not respond to the polling signal within a predetermined period of time (e.g., 10 seconds) are not electrically coupled to the integrated apparatus 101, 200 and, therefore, are not installed in the system 100. By contrast, the controller 114 may determine (317) that the electrical devices that did respond to the polling signal within the predetermined period of time are electrically coupled to the integrated apparatus 101, 200 and, therefore, are installed in the system 100. According to one embodiment, each poll response includes an identifier (e.g., serial number) inserted by the electrical device controller 136 to enable the integrated apparatus controller 114 to determine which electrical device 103-106 is responding to the polling signal. Additionally, the integrated apparatus controller 114 may be preprogrammed to know the maximum number of electrical devices 103-106 that may be simultaneously electrically coupled to the apparatus 101, 200. Thus, upon receiving responses to a particular polling signal or set of polling signals, the integrated apparatus controller 101, 200 may determine whether the maximum number of electrical devices 103-106 that could have responded did respond. If the maximum number of electrical devices 103-106 did respond, the integrated apparatus controller 114 may determine that the maximum number of electrical devices 103-106 is electrically coupled to the apparatus 101, 200. Otherwise, the integrated apparatus controller 114 may determine that less than the maximum quantity of electrical devices 103-106 is electrically coupled to the apparatus 101, 200. Knowledge of which electrical devices 103-106 are installed and operational may be important for implementing individual control of the electrical devices 103-106, such as when executing a visual effects routine or other program utilizing the electrical devices 103-106.

In addition to determining which electrical devices 103-106 are present in the system 100, the integrated apparatus controller 114 may receive (319) data from the electrical devices 103-106 that responded to the polling signals. The data may be received in response to the polling signals (e.g., where the polling signals included requests for information), automatically (e.g., at periodic reporting periods programmed into the controllers 136 of the electrical devices 103-106), or in response to separate requests for information sent to the electrical devices 103-106. The received data may include a variety of data, including device identification data, time in use data, power consumption data, warranty information, error report data (e.g., due to execution errors of programs executed by the electrical device controller 136), and any other data necessary for the integrated apparatus controller 114 or the host device 123, as applicable, to appropriately monitor and/or control the electrical devices 103-106. In one embodiment, some or all of the received data for a particular electrical device 103-106 may be data stored in the memory 138 of the electrical device 103-106.

Upon receipt of the data, the integrated apparatus controller 114 may store the data in memory 118, report the data to the host device 123, determine electrical device-related status or operational information (e.g., power usage) from the data, and/or compare the data to one or more associated thresholds. For example, where the received data includes power consumption data, the integrated apparatus controller 114 may compare the received power consumption data to a power usage threshold to determine whether the electrical device 103-106 is operating within normal specifications or within specifications associated with a particular class of devices (e.g., ENERGY STAR compliant devices). Alternatively, where the received data includes time in use data and warranty information, the integrated apparatus controller 114 may compare the time in use data to the warranty time period to determine whether the electrical device is still under warranty. Still further, where the received data includes device identifier data, the integrated apparatus controller 114 may compare the device identifier data with previously stored device identifiers to determine whether any new electrical devices have been installed.

Alternatively or additionally, the integrated apparatus controller 114 may determine power usage or consumption data for one or more of the electrical devices 103-106 and store the data in memory 118 or report the data to a host device 123. In one embodiment, one or more of the electrical devices 103-106 may include current and voltage detection circuitry, and the device's controller 136 may compute the device's power consumption based on the detected voltage and current and store the computed consumption data, and optionally the detected current and voltage, in device memory 138. The stored power consumption information (e.g., voltage, current, and/or calculated power) may be communicated to the integrated apparatus controller 114 in response to a polling signal or another request for information from the integrated apparatus controller 114. Upon receiving the power consumption data from an electrical device 103-106, the integrated apparatus controller 114 may determine power usage data for the electrical device 103-106 either by directly retrieving the power usage data from the received information or by computing the power consumption data from the received information (e.g., from received current and voltage information). The integrated apparatus controller 114 may then store the power usage data in memory 118 for future use (e.g., to compare to or average with future power usage data, such as to determine whether the reporting electrical device 103-106 may be malfunctioning in some way (e.g., may have a defective LED)) or report it to a host device 123).

The present invention encompasses an integrated power hub and device controller apparatus, and associated operational method, operable to control and supply power to electrical devices that operate in environments which create a high risk for the electrical devices to generate stray voltages and currents. With this invention, power distribution and electrical device control may be integrated into a single housing that may be positioned near a system that includes electrical load devices which are at a high risk for producing stray currents and voltages. Positioning of the power distribution facility near the system reduces line losses between the facility and the electrical loads being supplied. Additionally, through use of a separate transformer-based, AC-to-DC converter circuit for each electrical load device, the integrated apparatus isolates the load devices from stray currents which may be generated due to the devices' locations in high risk areas, such as in or around aquatic systems. Additionally, providing for detection of new and/or replacement electrical load devices that are coupled to the apparatus allows the apparatus to keep track of which electrical devices are present for purposes of sending control signals, requesting information, and/or performing other functions (e.g., power usage monitoring). Thus, the present invention provides an enhanced, integrated, multi-function apparatus that may be used to replace the separate power distribution and control devices currently used to supply power to and control electrical devices used with aquatic and other systems.

As detailed above, embodiments of the present invention reside primarily in combinations of method steps and apparatus components related to implementing and operating an integrated power hub and device controller apparatus. Accordingly, the apparatus components and method steps have been represented, where appropriate, by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as “first” and “second,” “top” and “bottom,” and the like may be used solely to distinguish one object or action from another object or action without necessarily requiring or implying any actual relationship or order between such objects or actions. The terms “includes,” “comprises,” “has,” “contains,” “including,” “comprising,” “having,” “containing,” and any other variations thereof are intended to cover a non-exclusive inclusion, such that a process, method, article, or apparatus that includes, comprises, has or contains a list of elements, features or functions does not include only those elements, features or functions, but may include other elements, features or functions not expressly listed or inherent to such process, method, article, or apparatus. The term “plurality of” as used in connection with any object or action means two or more of such object or action. A claim element proceeded by the article “a” or “an” does not, without more constraints, preclude the existence of additional identical elements in the process, method, article, or apparatus that includes the element.

It will be appreciated that embodiments of the integrated power hub and device controller apparatus 101, 200 described herein may be comprised of one or more conventional processors (e.g., implementing the controller 114) and unique stored program instructions that control the processor(s) to implement, in conjunction with certain non-processor circuits, some, most, or all of the control functions of the integrated apparatus 101, 200 and its operational methods as described herein. The non-processor circuits may include, but are not limited to, memory 118, the dusk-dawn sensor 124, the timer 126, as well as filters, communication interface circuits, clock circuits, and various other non-processor circuits. As such, the functions of these non-processor circuits may be interpreted as steps of a method to control electrical devices that operate in environments which create a high risk for the devices to generate stray voltages and currents. Alternatively, some or all functions of the controller 114 could be implemented by a state machine that has no stored program instructions, or in one or more application specific integrated circuits (ASICs), in which each function or some combinations of certain of the functions are implemented as custom logic. Of course, a combination of the above approaches could be used. Thus, methods and means for these functions have been generally described herein. Further, it is expected that one of ordinary skill in the art, notwithstanding possibly significant effort and many design choices motivated by, for example, available time, current technology, and economic considerations, when guided by the concepts and principles disclosed herein, will be readily capable of generating such software instructions or programs and integrated circuits without undue experimentation.

In the foregoing specification, specific embodiments of the present invention have been described. However, one of ordinary skill in the art will appreciate that various modifications and changes can be made without departing from the scope of the present invention as set forth in the appended claims. For example, the converter circuits 109-112 may be essentially identical and produce substantially identical DC output voltages or the converter circuits 109-112 may be different and produce different DC output voltages. As another example, the configuration of the integrated apparatus housing may be different than the housing shown in FIG. 2, and may incorporate an ornamental design that allows the housing to blend into a user's landscaping. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as critical, required, or essential features or elements of any or all the claims.

What is claimed is:

1. An integrated power hub and device controller apparatus for controlling and supplying power to a plurality of electrical devices that operate in environments which create a high risk for the plurality of electrical devices to generate stray voltages and currents, the apparatus comprising:
a plurality of converter circuits that convert input alternating current (AC) power to direct current (DC) power, each converter circuit providing a DC output voltage for a respective electrical device of the plurality of electrical devices, the plurality of converter circuits being configured so as to mitigate stray currents from flowing between the plurality of electrical devices;
a controller operable to generate control signals so as to at least partially control operations of the plurality of electrical devices; and
a communication interface operably coupled to the controller and operable to provide the control signals to the plurality of electrical devices.

2. The apparatus of claim 1, wherein the plurality of electrical devices are used in connection with an aquatic system.

3. The apparatus of claim 2, wherein the aquatic system includes at least one of a swimming pool and a fountain.

4. The apparatus of claim 2, further comprising:
a housing that surrounds the plurality of converter circuits and the controller, wherein the housing is installable near the aquatic system.

5. The apparatus of claim 2, wherein the plurality of electrical devices are controllable to create visual effects with respect to the aquatic system and wherein the control signals cause the plurality of electrical devices to create the visual effects.

6. The apparatus of claim 1, wherein the DC output voltage from each converter circuit is substantially identical.

7. The apparatus of claim 1, wherein each converter circuit includes a step-down transformer.

8. The apparatus of claim 1, wherein the communication interface is a RS485 serial interface.

9. The apparatus of claim 1, wherein the controller is further operable to:
provide polling signals to the communication interface for communication to the plurality of electrical devices;
receive one or more responses to the polling signals from a respective one or more of the plurality of electrical devices via the communication interface; and
determine which of the plurality of electrical devices are electrically coupled to the apparatus based on the one or more responses.

10. The apparatus of claim 9, wherein the polling signals include requests for information from the plurality of electrical devices.

11. The apparatus of claim 10, wherein an electrical device of the plurality of electrical devices includes memory operable to store data relating to the electrical device and wherein a polling signal directed to the electrical device includes a request for at least some of the data.

12. The apparatus of claim 11, wherein the controller is further operable to receive the data from the electrical device via the communication interface and compare at least some of the data to associated thresholds.

13. The apparatus of claim 1, further comprising memory, wherein the controller is further operable to determine power usage data for each of the plurality of electrical devices and store the power usage data in the memory.

14. The apparatus of claim 1, further comprising a user interface operably coupled to the controller, wherein the controller is further operable to indicate statuses of the plurality of electrical devices.

15. The apparatus of claim 1, further comprising:
a second communication interface operably coupled to the controller and operable to receive host control signals from a remote host device,
wherein the controller is operable to generate one or more of the control signals in response to the host control signals.

16. The apparatus of claim 1, further comprising:
a timer operably coupled to the controller, wherein the controller is further operable to generate one or more of the control signals based on an output of the timer.

17. The apparatus of claim 1, further comprising:
a dusk-dawn sensor coupled to the controller, wherein the controller is further operable to generate one or more of the control signals based on an output of the dusk-dawn sensor.

18. The apparatus of claim 1, wherein the controller is further operable to generate the control signals so as to individually control operations of the plurality of electrical devices.

19. An integrated power hub and device controller apparatus for controlling and supplying power to a plurality of electrical devices that are used in connection with an aquatic system, the apparatus comprising:
an alternating current (AC) power input for receiving AC power from an external power source;
a plurality of converter circuits electrically coupled to the AC power input and operable to convert the received AC power to direct current (DC) power, each converter circuit providing a respective DC output voltage for a respective electrical device of the plurality of electrical devices, each of the plurality of converter circuits including a step-down transformer so as to mitigate stray currents from flowing between the plurality of electrical devices;
a plurality of DC power output connectors, each DC power output connector being electrically coupled to a respective converter circuit of the plurality of converter circuits and supplying the respective DC output voltage to the respective electrical device;
a controller operable to generate control signals that cause the plurality of electrical devices to create visual effects with respect to the aquatic system; and
a communication interface operably coupled to the controller and operable to provide the control signals to the plurality of electrical devices.

20. The apparatus of claim 19, wherein the controller is further operable to:
provide polling signals to the communication interface for communication to the plurality of electrical devices;
receive one or more responses to the polling signals from a respective one or more of the plurality of electrical devices via the communication interface; and
determine which of the plurality of electrical devices are electrically coupled to the apparatus based on the one or more responses.

21. The apparatus of claim 20, wherein the polling signals include requests for information from the plurality of electrical devices.

22. The apparatus of claim 21, wherein an electrical device of the plurality of electrical devices includes memory operable to store data relating to the electrical device and wherein a polling signal directed to the electrical device includes a request for at least some of the data.

23. The apparatus of claim 19, further comprising memory, wherein the controller is further operable to determine power usage data for each of the plurality of electrical devices and store the power usage data in the memory.

24. The apparatus of claim 19, further comprising:
a second communication interface operably coupled to the controller and operable to receive host control signals from a remote host device,
wherein the controller is operable to generate one or more of the control signals in response to the host control signals.

25. The apparatus of claim 19, wherein the controller is further operable to generate the control signals so as to individually control operations of the plurality of electrical devices.

26. An integrated power hub and device controller apparatus for controlling and supplying power to a plurality of electrical devices that operate in environments which create a high risk for the plurality of electrical devices to generate stray voltages and currents, the apparatus comprising:
a plurality of converter circuits that convert input alternating current (AC) power to direct current (DC) power, each converter circuit providing a DC output voltage for a respective electrical device of the plurality of electrical devices, each converter circuit including a step-down transformer and being configured so as to mitigate stray currents from flowing between the plurality of electrical devices;
a first communication interface operable to receive host control signals from a remote host device;
a controller operably coupled to the first communication interface and operable to generate device control signals in response to the host control signals so as to at least partially control operations of the plurality of electrical devices; and
a second communication interface operably coupled to the controller and operable to provide the device control signals to the plurality of electrical devices.

27. A method for an integrated power hub and device controller apparatus to control and supply power to a plurality of electrical devices that operate in environments which create a high risk for the plurality of electrical devices to generate stray voltages and currents, the method comprising:
receiving alternating current (AC) power from a single AC power source;
converting the received AC power into a plurality of substantially isolated direct current (DC) output voltages;
supplying each DC output voltage to a respective one of the plurality of electrical devices;
generating control signals for at least partially controlling operations of the plurality of electrical devices; and
communicating the control signals to the plurality of electrical devices.

28. The method of claim 27, further comprising:
communicating polling signals to each of the plurality of electrical devices;
receiving one or more responses to the polling signals from a respective one or more of the plurality of electrical devices; and
determining which of the plurality of electrical devices are electrically coupled to the apparatus based on the one or more responses.

29. The method of claim 28, further comprising:
determining that an electrical device is not electrically coupled to the apparatus when a response to a polling signal communicated to the electrical device is not received.

30. The method of claim 28, wherein an electrical device of the plurality of electrical devices includes memory operable to store data relating to the electrical device and wherein a polling signal communicated to the electrical device includes a request for at least some of the data.

31. The method of claim 27, further comprising:
receiving a host control signal from a remotely located host device; and
generating at least one of the control signals responsive to the host control signal.
